(19) United States
(12) Patent Application Publication
(10) Pub. No.: US 2018/0045099 A1
(43) Pub. Date: Feb. 15, 2018

(54) EXHAUST PURIFICATION DEVICE

(71) Applicant: Honda Motor Co.,Ltd., Tokyo (JP)

(72) Inventors: Hiroki YAMAMOTO, Saitama (JP); Yoshiaki HATAKEYAMA, Saitama (JP)

(73) Assignee: Honda Motor Co.,Ltd., Tokyo (JP)

(21) Appl. No.: 15/633,779

(22) Filed: Jun. 27, 2017

(30) Foreign Application Priority Data
Aug. 15, 2016 (JP) 2016-159322

(51) Int. Cl. F01N 3/28; B01D 53/94

(52) U.S. Cl. CPC F01N 3/2853; B01D 53/94

(57) ABSTRACT

An object is to provide an exhaust purification device capable of maintaining high holding power while preventing cracking in a mat during wrapping with a simple configuration. An exhaust purification device (1) includes a columnar honeycomb substrate (2), a belt-like mat (3) that includes a fibrous material and an inorganic binder and is wrapped around the honeycomb substrate (2), and a tubular casing (5) in which the honeycomb substrate (2) around which the mat (3) is wrapped is accommodated. The mat (3) includes an inner layer (31) in contact with the honeycomb substrate (2) and an outer layer (32) that is provided on the casing (5) side relative to the inner layer (31) and has a lower content of the inorganic binder than the inner layer (31).

### CROSS-REFERENCE TO RELATED APPLICATION

This application claims the priority benefit of Japan application serial no. 2016-159322, filed on Aug. 15, 2016. The entirety of the above-mentioned patent application is hereby incorporated by reference herein and made a part of this specification.

### BACKGROUND OF THE INVENTION

### Field of the Invention

The present invention relates to an exhaust purification device, and more specifically, to an exhaust purification device configured to accommodate an exhaust purification body around which a mat is wrapped in a casing.

### Description of Related Art

In an exhaust flow path of an engine, an exhaust purification device configured to purify a gas component such as HC, CO, and NOx contained in an exhaust and collect particulate matters (hereinafter referred to as “PM”) in an exhaust to purify the exhaust is provided. In the exhaust purification device, a columnar exhaust purification body having a function of purifying an exhaust is accommodated inside a tubular casing which is a part of an exhaust flow path. In this case, in order to prevent the exhaust purification body in the casing from being damaged due to vibration or impact and an exhaust from leaking from a gap between the casing and the exhaust purification body, the exhaust purification body is press-fitted into the casing while a thick fibrous mat is wrapped therearound. In addition, in order to increase holding power of the exhaust purification body by the mat and prevent a decrease in holding power due to aging deterioration, there are many mats including inorganic binders (for example, refer to Patent Document 1).

### PRIOR ART DOCUMENT

### Patent Documents

[Patent Document 1] PCT International Publication No. WO 2015/056652

### SUMMARY OF THE INVENTION

### Problem to be Solved by the Invention

Incidentally, when a content of an inorganic binder is set to be higher in order to increase holding power of a mat, fibers are strongly connected by the binder and the mat becomes hard. If the mat becomes hard, it is difficult to wrap the mat around an outer peripheral surface of the exhaust purification body when the exhaust purification device is produced, and cracking may occur in the mat during the wrapping. In order to prevent cracking in the mat, additional wrapping of a nonwoven fabric around the outside of the mat is also proposed. However, when the nonwoven fabric is used, production cost increases accordingly.

FIG. 6 is a diagram showing a state in which an exhaust purification device 100 of related art is wrapped. In the exhaust purification device 100 of the related art in which a mat 102 and a nonwoven fabric 103 are wrapped around an exhaust purification body 101, there are problems in that the mat 102 and the nonwoven fabric 103 are less likely to be fitted around the circumference of the exhaust purification body 101 during the wrapping, and surface pressure of a portion in which the mat is aligned is extremely increased.

The present invention provides an exhaust purification device capable of maintaining high holding power while preventing cracking in a mat during wrapping with a simple configuration.

### Technical Means Solving The problem

(1) An exhaust purification device (for example, an exhaust purification device 1 to be described below) according to the present invention includes a columnar exhaust purification body (for example, a honeycomb substrate 2 to be described below), a belt-like mat (for example, a mat 3 to be described below) wrapped around the exhaust purification body and a tubular casing (for example, a casing 5 to be described below) in which the exhaust purification body around which the mat is wrapped is accommodated. The mat includes a fibrous material and an inorganic binder. A content of the inorganic binder in the mat is lower on the casing side than the exhaust purification body side.

(2) In this case, the mat preferably includes an inner layer (for example, an inner layer 31 to be described below) in contact with the exhaust purification body and an outer layer (for example, an outer layer 32 to be described below) that is provided on the casing side relative to the inner layer and has a lower content of the inorganic binder than the inner layer.

### Effects of the Invention

(1) An exhaust purification device of the present invention is formed by wrapping a belt-like mat including a fibrous material and an inorganic binder around a columnar exhaust purification body and accommodating the body in a tubular casing. Here, when the inorganic binder is included in the mat, it is possible to connect fibers and increase holding power of the exhaust purification body by the mat. In addition, when the mat is wrapped around the exhaust purification body, the mat extends more largely on the casing side serving as the outside to the extent of the thickness thereof than on the exhaust purification body side serving as the inside. Therefore, in the exhaust purification device of the present invention, the content of the inorganic binder in the mat is lower on the casing side on which extension is great than on the exhaust purification body side on which extension is less during the wrapping. Accordingly, since the casing side is softer than the exhaust purification body side in the mat, it is possible to prevent cracking on the casing side during the wrapping. In addition, when the content of the inorganic binder of the exhaust purification body side is set to be higher than the content of the inorganic binder of the casing side, since it is possible to provide a sufficient amount of the inorganic binder in the entire mat, it is possible to increase holding power by the mat and reduce a decrease in holding power due to deterioration. As described above, according to the exhaust purification device of the present invention, it is possible to maintain high holding power while preventing cracking in the mat with a simple configuration.

(2) In the exhaust purification device of the present invention, the mat has a multilayer structure including two or more layers, an inner layer in contact with an exhaust purification body and an outer layer that is provided on the casing side relative to the inner layer and has a lower content of the inorganic binder than the inner layer. The mat having such a multilayer structure can be easily produced by, for example, laminating two mats whose contents of inorganic binders are different.

### BRIEF DESCRIPTION OF THE DRAWINGS

FIG. 1 is a perspective view of an exhaust purification device according to an embodiment of the present invention.

FIG. 2 is a development diagram of a mat.

FIG. 3 is a diagram showing a state in which a mat is wrapped around a catalyst converter.

FIG. 4 is a diagram schematically showing procedures of producing a mat having a 2-layer structure in which contents of inorganic binders are different in layers.

FIG. 5 is a diagram showing a deterioration characteristic of holding power of a mat.

FIG. 6 is a diagram schematically showing a change due to deterioration of an exhaust purification device of the related art.

### DESCRIPTION OF THE EMBODIMENTS

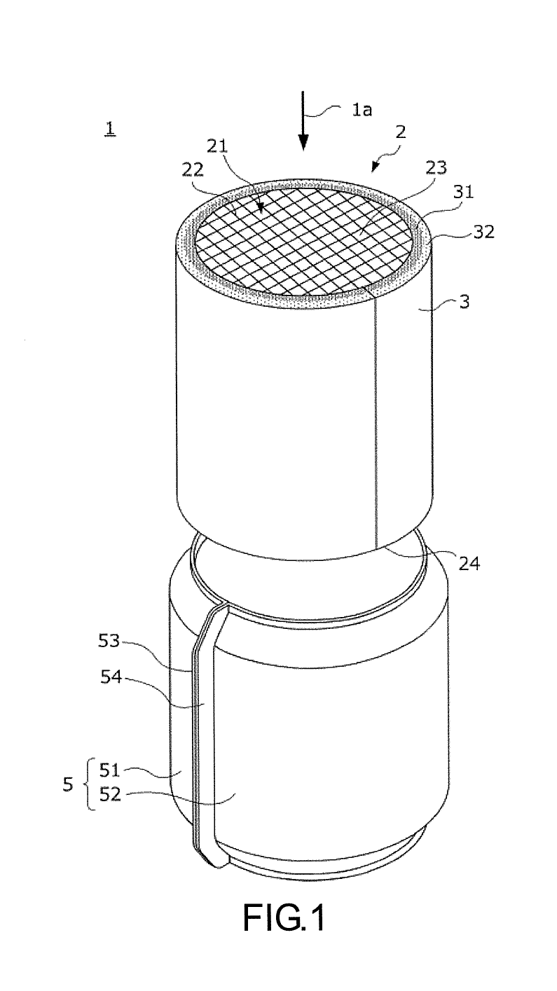

An embodiment of the present invention will be described below in detail with reference to the drawings. FIG. 1 is a perspective view of an exhaust purification device 1 according to the present embodiment. The exhaust purification device 1 is disposed along an exhaust path of an engine (not shown), and purifies an exhaust discharged from the engine under the reaction of an exhaust purification catalyst. More specifically, in a section (for example, in a section in an engine room in which an engine is placed) known as the region directly below the engine along the exhaust path of the engine, the exhaust purification device 1 is provided vertically in a mounting orientation of the vehicle, that is, provided such that an exhaust flow direction la and a vertical direction are substantially parallel to each other.

The exhaust purification device 1 includes a cylindrical honeycomb substrate 2, a belt-like mat 3 wrapped around the honeycomb substrate 2, and a tubular casing 5 in which the honeycomb substrate 2 around which the mat 3 is wrapped is accommodated.

The honeycomb substrate 2 has a cylindrical shape and includes a plurality of cells 21 that extend in the exhaust flow direction 1a from an inflow end 23 to an outflow end 24 and partition walls 22 that partition and form the cells 21, and is a flow-through type honeycomb structure body having no plugging at either of the ends 23 and 24 of the cells 21. An exhaust purification catalyst is supported on the partition wall 22. An exhaust flowed into the cells 21 from the inflow end 23 is purified while flowing in the flow direction 1a in the cells 21 under a reaction of the exhaust purification catalyst.

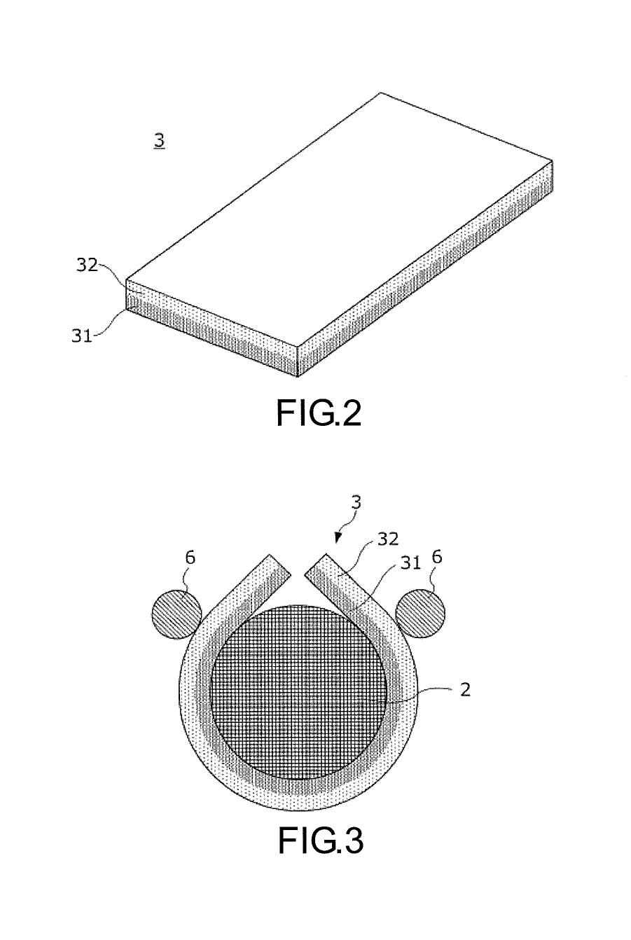

FIG. 2 is a development diagram of the mat 3. The belt-like mat 3 includes a fibrous material and an inorganic binder that connects the fibrous material. As the fibrous material, a heat-resistant inorganic fiber such as an alumina fiber, a mullite fiber, a silica fiber, an alumina silica fiber, or a ceramic glass fiber is used. In addition, as the inorganic binder, for example, an inorganic binder containing alumina particles is used. The mat 3 is wound around an outer peripheral surface of the cylindrical honeycomb substrate 2 by a roller 6 (refer to FIG. 3). In addition, the honeycomb substrate 2 around which the mat 3 is wrapped is accommodated in the casing 5 (refer to FIG. 1).

A content of the inorganic binder of the mat 3 is different between a part in contact with the honeycomb substrate 2 and a part in contact with the casing 5 in the thickness direction. More specifically, in the mat 3, the content of the inorganic binder of the part in contact with the casing 5 is lower than the content of the inorganic binder of the part in contact with the honeycomb substrate 2 in the thickness direction.

As described above, the mat 3 whose content of the inorganic binders is different in the thickness direction is formed with, for example, a multilayer structure that is obtained by laminating a plurality of layers whose contents of inorganic binders are different. More specifically, the mat 3 has a 2-layer structure in which an inner layer 31 in contact with the honeycomb substrate 2 and an outer layer 32 in contact with the casing 5 are laminated. In addition, the content of the inorganic binder of the outer layer 32 is lower than the content of the inorganic binder of the inner layer 31. For example, the content of the inorganic binder in the inner layer 31 is 3.5 mass % with respect to the entire inner layer 31 including the fibrous material and the inorganic binder. The content of the inorganic binder in the outer layer 32 is 0.8 mass % with respect to the entire outer layer 32 including the fibrous material and the inorganic binder.

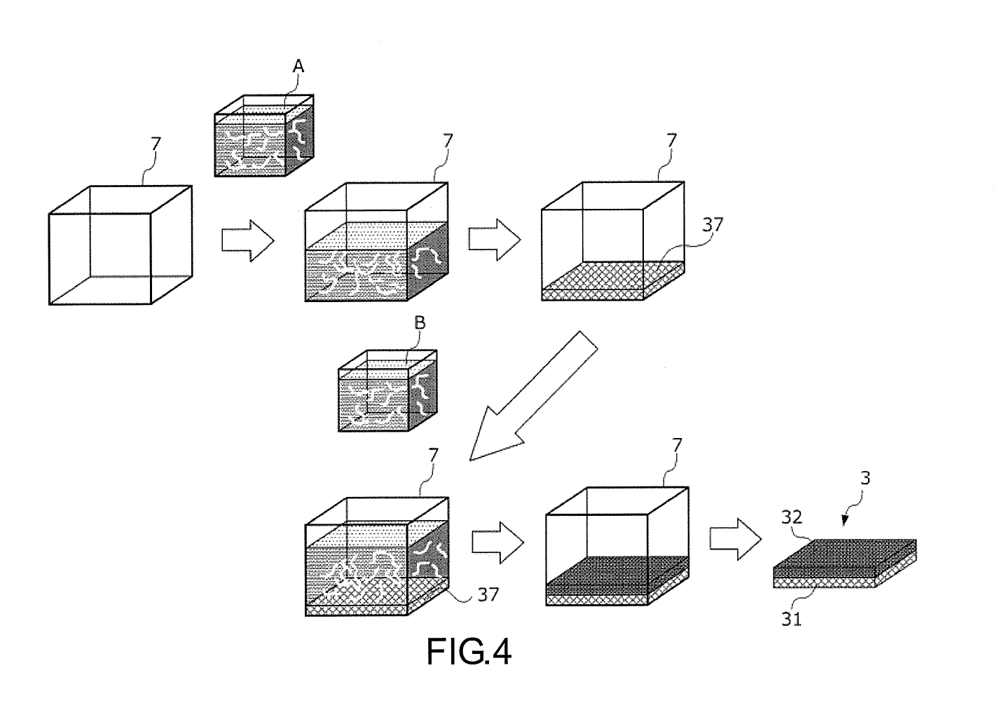

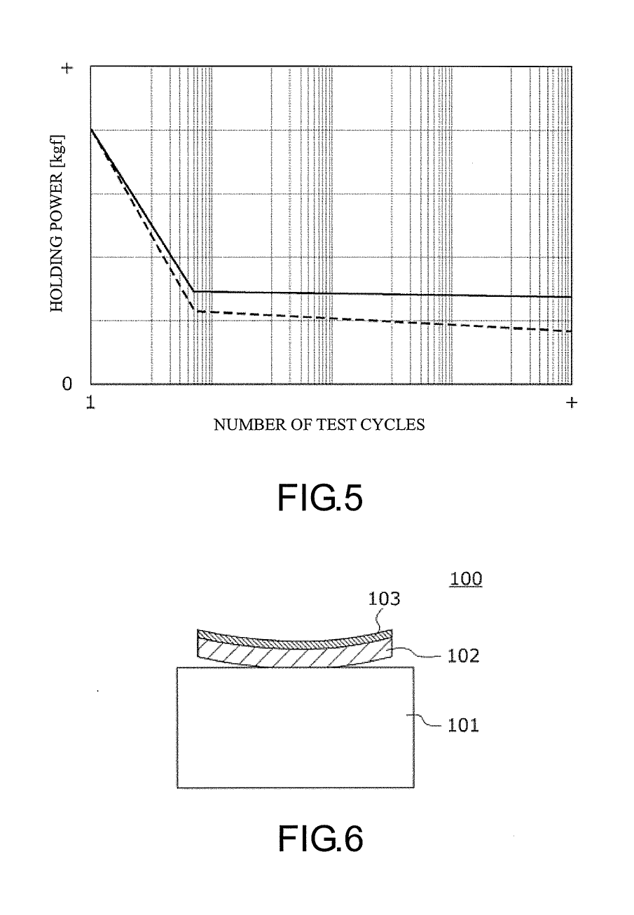

FIG. 4 is a diagram schematically showing procedures of producing the mat 3 having a 2-layer structure in which contents of inorganic binders are different in layers. First, a fiber stirring solution A obtained by mixing and stirring water, a fibrous material, and an inorganic binder at a predetermined ratio is put into a molding tank 7, water contained in the fiber stirring solution A is removed by dehydration and drying in the molding tank 7, and thus a single layer mat 37 which will become the inner layer 31 is formed.

Next, a fiber stirring solution B obtained by mixing and stirring water, a fibrous material, and an inorganic binder at a predetermined ratio is put into the molding tank 7 in which the previously formed single layer mat 37 as described above is laid, water contained in the fiber stirring solution B is removed by dehydration and drying in the molding tank 7, and therefore the mat 3 including the inner layer 31 that is a bottom side and the outer layer 32 that is a top side in the molding tank 7 is formed. Here, in the previously formed single layer mat 37, a part of the inorganic binder contained in the fiber stirring solution B is immersed. Therefore, the outer layer 32 is connected to the inner layer 31 by the inorganic binder. The content of the inorganic binder is higher in the bottom side inner layer 31 than the top side outer layer 32.

Returning to FIG. 1, as described above, the casing 5 has a cylindrical shape and accommodates the honeycomb substrate 2 around which the mat 3 is wrapped therein. The casing 5 is a case member of a so-called clamshell type that is divided into two case halves 51 and 52 by a plane including the central axis. Inner diameters of the case halves 51 and 52 are slightly smaller than the outer diameter of the mat 3 wrapped around the honeycomb substrate 2. The casing 5 is formed when the honeycomb substrate 2 around which the mat 3 is wrapped is disposed between the two case halves 51 and 52, the mat 3 is compressed in the thickness direction by the case halves 51 and 52 and is combined in flange parts 53 and 54 provided in the case halves 51 and 52, and the flange parts 53 and 54 are welded for integration. When the mat 3 is compressed in this manner, surface pressure by the mat 3 is applied to an outer peripheral surface of the honeycomb substrate 2. Therefore, the honeycomb substrate 2 is held at a specific position inside the casing 5.

According to the exhaust purification device 1 of the present embodiment, the following effects are obtained.

(1) The exhaust purification device 1 is formed by wrapping the belt-like mat 3 including a fibrous material and an inorganic binder around the honeycomb substrate 2 and accommodating the body in the casing 5. When the inorganic binder is included in the mat 3, it is possible to connect fibers and increase holding power of the honeycomb substrate 2 by the mat 3. In addition, in the exhaust purification device 1, the content of the inorganic binder in the mat 3 is lower in the outer layer 32 on the casing 5 side on which extension is great than in the inner layer 31 on the honeycomb substrate 2 on which extension is less during the wrapping. Accordingly, since the outer layer 32 is softer than the inner layer 31 in the mat 3, it is possible to prevent cracking in the outer layer 32 during the wrapping.

FIG. 5 is a diagram showing a deterioration characteristic of holding power of a mat. More specifically, FIG. 5 is a diagram showing changes in holding power [kgf] of mats when a heat load assumed as exhaust heat is repeatedly applied to two types of mats in which contents of inorganic binders are different for a plurality of test cycles. In FIG. 5, the solid line indicates a mat in which the content of the inorganic binder is 3.5 mass % and the dashed line indicates a mat in which the content of the inorganic binder is 0.8 mass %.

As shown in FIG. 5, holding power of the mat when it is produced at first is almost the same regardless of the content of the inorganic binder. In addition, holding power of each mat has a characteristic that, when a heat load is applied, it is quickly reduced, and is then gently reduced. As shown in FIG. 5, the mat in which the content of the inorganic binder is high maintains higher holding power than the mat in which the content of the inorganic binder is low for all test cycles. In addition, holding power decreases more gently in the mat in which the content of the inorganic binder is high than in the mat in which the content of the inorganic binder is low.

Here, according to the exhaust purification device 1, when the content of the inorganic binder of the inner layer 31 is set to be higher than the content of the inorganic binder of the outer layer 32, since it is possible to provide a sufficient amount of inorganic binder in the entire mat 3, it is possible to increase holding power of the honeycomb substrate 2 by the mat 3 and reduce a decrease in holding power due to deterioration. As described above, according to the exhaust purification device 1, it is possible to prevent cracking in the mat 3 and maintain high holding power with a simple configuration.

(2) In the exhaust purification device 1, the mat 3 has a 2-layer structure that includes the inner layer 31 in contact with the honeycomb substrate 2 and the outer layer 32 that is provided on the casing 5 side relative to the inner layer 31 and has a lower content of the inorganic binder than the inner layer 31. Therefore, as described above, it is possible to prevent cracking in the mat 3 and maintain high holding power. In addition, as described with reference to FIG. 4, the mat 3 having such a 2-layer structure can be easily produced by laminating two mats whose contents of inorganic binders are different.

While the embodiment of the present invention has been described above, the present invention is not limited thereto. Detailed configurations may be appropriately changed within the scope of the present invention.

For example, while the exhaust purification device in which the mat 3 is wrapped around the flow-through type honeycomb substrate 2 and the mat is accommodated in the casing 5 has been exemplified in the above embodiment, an object around which the mat 3 is wrapped is not limited thereto. The object around which the mat is wrapped may be a wall flow type filter substrate obtained by alternately providing pluggings for adjacent cells in an inflow end and an outflow end of an exhaust in cells in addition to the above-described honeycomb substrate.

In addition, while the mat 3 in which the content of the inorganic binder is lower on the casing 5 side than the honeycomb substrate 2 side is obtained by laminating the inner layer 31 and the outer layer 32 having a lower content of the inorganic binder than the inner layer 31 in the above embodiment, the present invention is not limited thereto. For example, a mat in which contents between inorganic binders of the honeycomb substrate 2 side and the casing 5 side are different may be formed by continuously decreasing the content of the inorganic binder from the honeycomb substrate 2 side to the casing 5 side in the thickness direction of the mat.

In addition, although the 2-layer structure mat 3 including the inner layer 31 and the outer layer 32 has been exemplified in the above embodiment, the present invention is not limited thereto. The mat may include three or more layers. In this case, it is preferable that contents of inorganic binders of the layers be lowered from the inner layer to the outer layer.

What is claimed is:

1. An exhaust purification device comprising:
a columnar exhaust purification body;
a belt-like mat that is wrapped around the exhaust purification body; and
a tubular casing in which the exhaust purification body around which the mat is wrapped is accommodated,
wherein the mat includes a fibrous material and an inorganic binder, and
wherein a content of the inorganic binder in the mat is lower on the casing side than the exhaust purification body side.

2. The exhaust purification device according to claim 1,
wherein the mat includes an inner layer that is in contact with the exhaust purification body and an outer layer that is provided on the casing side relative to the inner layer and has a lower content of the inorganic binder than the inner layer.
